(19) United States
(12) Patent Application Publication
(10) Pub. No.: US 2008/0116299 A1
(43) Pub. Date: May 22, 2008

(54) Compound spray gun

(76) Inventor: Chin-Chung Wang, Taichung (TW)

Correspondence Address: CHIN-CHUNG WANG, 235 Chung - Ho, Box 8-24, Taipei, omitted

(21) Appl. No.: 11/601,805

(22) Filed: Nov. 20, 2006

(51) Int. Cl. B05B 1/30

(52) U.S. Cl. 239/527

(57) ABSTRACT

A compound spray gun comprises a tube body having an approximate L shape; one end of the tube body being installed with a spray head; a front surface of the spray head having a plurality of water outlets which have different forms; an interior of the tube body having two flow channels which penetrate through the tube body; a receiving body filled with additive being detachably installed to a lower end of the tube body; a guide post being axially installed in the receiving body; one end of the guide post exposing from the tube body for being connected to a cleaning running water; another end of the guide post in the receiving body being connected to one flow channel; and a key being pivoted to the tube body.

### FIELD OF THE INVENTION

The present invention relates to spraying guns, and particularly to a compound spray gun, which can provide various forms of spray objects by rotating a spraying head so that clean agent and clean water can be sprayed out by using only one spraying gun. The operation of the spraying gun is convenient and easy.

### BACKGROUND OF THE INVENTION

One prior art about the spray gun has a water stop stud and a guide pin as a push button for controlling the input of water.

However, the prior art can reduce waste of water. Furthermore the spray head can provide various forms of spraying hole so as to present various patterns of the spraying water by rotating the spray head respective the tube body of the spray gun.

This prior art is insufficient in use, for example, as the spray gun is used to remove dust from the car body. Only spraying water is insufficient. Generally, clean agent is necessary, but the spray gun has only one flow channel and thus the clean agent is coated upon the car body and then the water is sprayed out from the spray gun. Or only water can be sprayed out from the spray gun. Thus this will induce some inconveniences to users.

### SUMMARY OF THE INVENTION

Accordingly, the primary object of the present invention is to provide a compound spray gun, which can provide various forms of spray objects by rotating a spraying head so that clean agent and clean water can be sprayed out by using only one spraying gun. The operation of the spraying gun is convenient and easy.

To achieve above objects, the present invention provides a compound spray gun comprising: a tube body having an approximate L shape; one end of the tube body being installed with a spray head; a front surface of the spray head having a plurality of water outlets which have different forms; an interior of the tube body having two flow channels which penetrate through the tube body; a receiving body filled with additive being detachably installed to a lower end of the tube body; a guide post being axially installed in the receiving body; one end of the guide post exposing from the tube body for being connected to a cleaning running water; another end of the guide post in the receiving body being connected to one flow channel; and a key being pivoted to the tube body; a switch passing through two lateral sides of the key; two sides of the switch having a first stop and a second stop which resist against the two lateral sides of the key; a pin passing through the two lateral sides of the key and the pivotal post of the tube body so that the key being pivotally connected to the tube body.

The various objects and advantages of the present invention will be more readily understood from the following detailed description when read in conjunction with the appended drawing.

### BRIEF DESCRIPTION OF THE DRAWINGS

FIG. 1 is an exploded schematic view of the compound spray gun of the present invention.

FIG. 2 is a lateral schematic view about the compound spray gun of the present invention.

FIG. 3 is a schematic view showing the details of the switching of the present invention.

FIG. 4 is a lateral schematic view about the application of FIG. 3.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

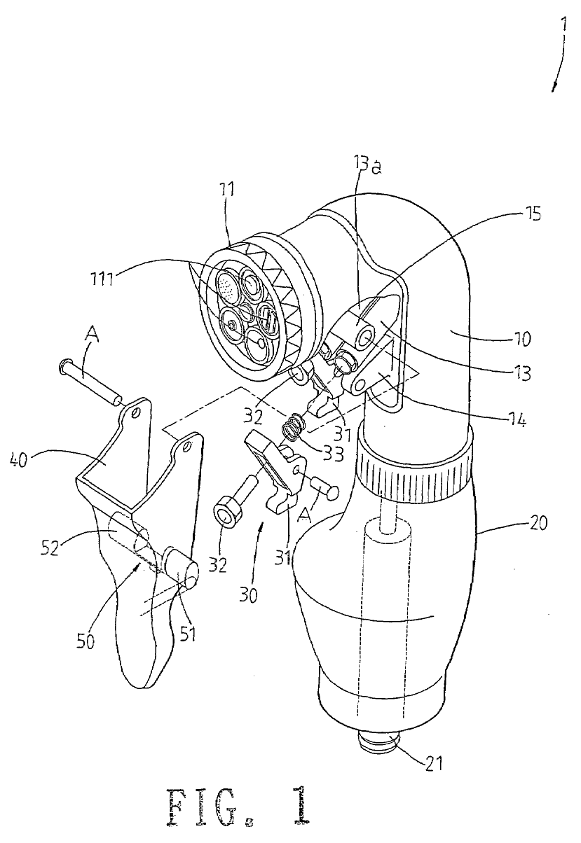

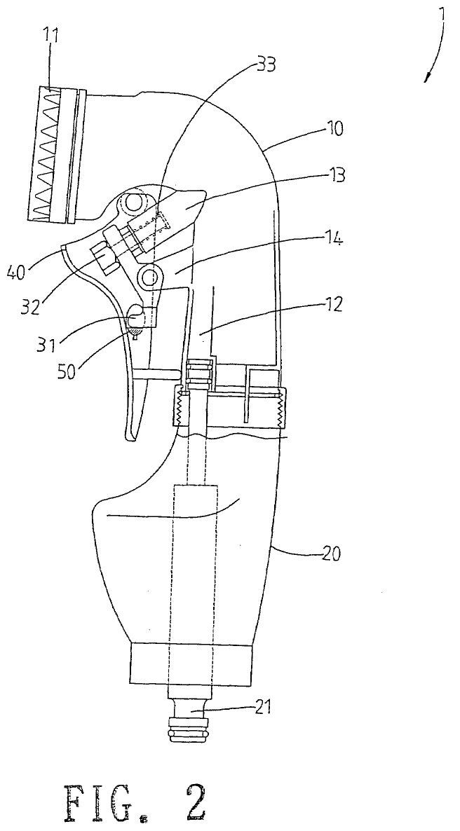

Referring to FIGS. 1 and 2, the compound spray gun 1 of the present invention is illustrated.

A tube body 10 has an approximate L shape. One end of the tube body 10 is installed with a spray head 11. A front surface of the spray head 11 has a plurality of water outlets 111 which have different forms. A user can rotate the spray head 11 so as to form different spray patterns. An interior of the tube body 10 has two flow channels 12 (only one is illustrated) which penetrate through the tube body 10. Two hollow posts 13, 13a extend from a bending portion of the L shape tube body 10. The hollow posts 13, 13a are communicated to the two flow channels 12, respectively. A lower side of each hollow post 13, 13a is extended with a pivotal ear 14. Upper sides of the two hollow posts 13, 13a have pivotal posts 15.

A receiving body 20 is filled with additive (such as cleaning agents, or medical agents) is detachably screwed to a lower end of the tube body 10. A guide post 21 is axially installed in the receiving body 20. One end of the guide post 21 exposes from the tube body 10 for being connected to a cleaning running water. Another end of the guide post 21 in the receiving body 20 is connected to one flow channel 12.

Two water control units 30 are included. Each water control unit 30 has a switch key 31, a guide pin 32, and an elastic element 33. A pin A passes through the switch key 31 so as to be pivotally connected to a respective pivotal ear 14. The guide pin 32 passes through the switch key 31 and is sleeved by the elastic element 33, and then penetrates through a respective hollow post 13, 13a and finally enters into the flow channel 12, 12a. As a result, normally, the guide pin 32 will seal the flow channel 12, 12a so that the flow channel 12 is blocked by the guide pin 32.

A key 40 has a U shape cross section. A switch 50 passes through two lateral sides of the key 40. Two sides of the switch 50 have a first stop 51 and a second stop 52 which resist against the two lateral sides of the key 40. A pin A passes through the two lateral sides of the key 40 and the pivotal post 15 of the tube body 10 so that the key 40 is pivotally connected to the tube body 10.

The function of the present invention will be described herein with reference to FIGS. 2, 3 and 4. Normally, the central recess of the switch 50 is corresponding to the switch keys 31 of the two water control units 30. When the key 40 is pressed, it can not control the two water control units 30 so that water can not be sprayed out. This is because the key 40 must move through a long distance.

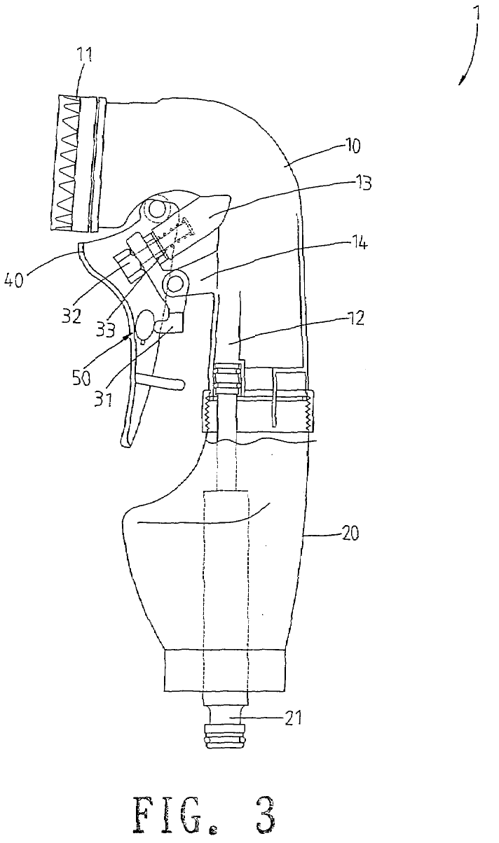

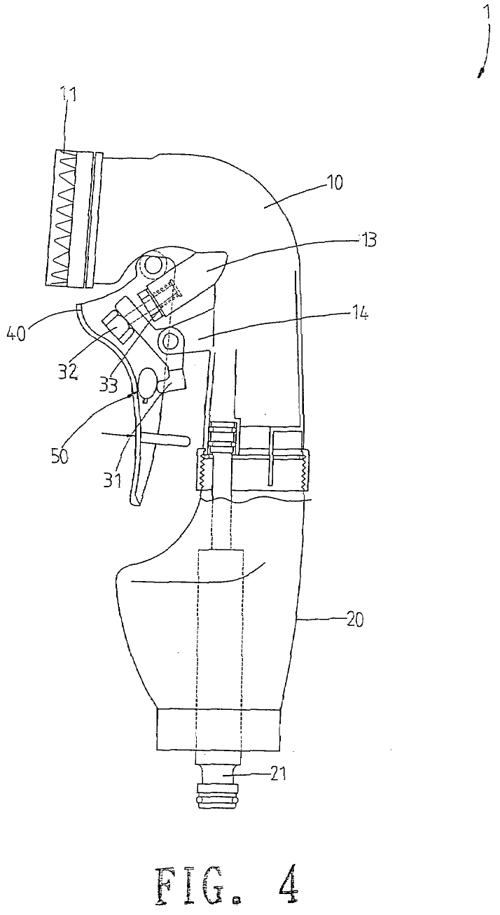

Referring to FIG. 3, when the switch 50 is moved leftwards. The first stop 51 at the right side will resist against the switch key 31 at the lower side of the first hollow post 13. Referring to FIG. 4, when the key 40 is pressed, the switch key 31 of the water control unit 30 will reduce inwards so that the guide pin 32 moves along a wall of the first hollow post 13 to close the flow channel 12 of the guide post 21. Thus clean running water flows through the guide post 21 will spray out from the water outlet 111.

When it is desired to clean a car or kill insects, the switch 50 of the key 40 moves rightwards so that the second stop 52 resists against the switch key 31 at the lower end of the second hollow post 13a. When the key 40 reduces inwards, the guide pin 32 will move outwards to open the flow channel 12 connected to the receiving body 20. The liquid in the receiving body 20 will mix with the additive according to the object to be cleaned and then spray out from the water outlet 111 for cleaning car or killing insects, etc.

In the compound spray gun 1 of the present invention, by the independent flow channels 12 and the receiving body 20 with additives and the key 40 passing through the switch 50 for controlling the flow channels 12, the liquid can be mixed with the additive in the receiving body 20 easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A compound spray gun comprising:
a tube body having an approximate L shape; one end of the tube body being installed with a spray head; a front surface of the spray head having a plurality of water outlets which have different forms; an interior of the tube body having two flow channels which penetrate through the tube body;
a receiving body filled with additive being detachably installed to a lower end of the tube body; a guide post being axially installed in the receiving body; one end of the guide post exposing from the tube body for being connected to a cleaning running water; another end of the guide post in the receiving body being connected to one flow channel; and
a key being pivoted to the tube body; a switch passing through two lateral sides of the key; two sides of the switch having a first stop and a second stop which resist against the two lateral sides of the key; a pin passing through the two lateral sides of the key and the pivotal post of the tube body so that the key being pivotally connected to the tube body.

2. The compound spray gun as claimed in claim 1, further comprising:
two hollow posts extending from a bending portion of the L shape tube body; the hollow posts being communicated to the two flow channels respectively; a lower side of each hollow post being extended with a pivotal ear; an upper sides of the two hollow posts having a pivotal post.

3. The compound spray gun as claimed in claim 1, further comprising:
two water control units; each water control unit having a switch key, a guide pin, and an elastic element; a pin passing through the switch key so as to be pivotally connected to a respective pivotal ear; the guide pin passing through the switch key and being sleeved by the elastic element, and then penetrating through a respective hollow post and finally entering into the flow channel; normally, the guide pin will seal the flow channel so that the flow channel is blocked by the guide pin.

4. The compound spray gun as claimed in claim 1, wherein the plurality of water outlets which have different forms.

5. The compound spray gun as claimed in claim 1, wherein the receiving body is detachably screwed to a lower end of the tube body.

6. A compound spray gun comprising:
a tube body having an approximate L shape; one end of the tube body being installed with a spray head; a front surface of the spray head having a plurality of water outlets which have different forms; an interior of the tube body having two flow channels which penetrate through the tube body;
a receiving body filled with additive being detachably installed to a lower end of the tube body; a guide post being axially installed in the receiving body; one end of the guide post exposing from the tube body for being connected to a water source; another end of the guide post in the receiving body being connected to one flow channel; and
a key being pivoted to the tube body; a switch passing through two lateral sides of the key; two sides of the switch having a first stop and a second stop which resist against the two lateral sides of the key; a pin passing through the two lateral sides of the key and the pivotal post of the tube body so that the key being pivotally connected to the tube body.
